(19) United States
(12) Patent Application Publication
(10) Pub. No.: US 2026/0321019 A1
(43) Pub. Date: Oct. 15, 2026

(54) SYSTEM, DEVICE AND METHOD FOR MONITORING TRAFFIC AND NATURAL ENVIRONMENTS

(71) Applicant: i8 Labs, Inc., Mountain View, CA (US)

(72) Inventors: Kouji Kodera, Mercer Island, WA (US); Stephane Maes, Mountain View, CA (US); Brian Boum, Seattle, WA (US); Majimath Chatterjee, Alameda, CA (US); Stuart Neubarth, Mountain View, CA (US); Brian Lue, Mountain View, CA (US)

(21) Appl. No.: 19/718,970

(22) Filed: Jun. 24, 2026

Related U.S. Application Data
(63) Continuation of application No. PCT/US24/62361, filed on Dec. 30, 2024.
(60) Provisional application No. 63/615,560, filed on Dec. 28, 2023.

(51) Int. Cl. G06V 20/54; G06T 7/246; G06T 11/26; G06V 10/25; G06V 10/764; G06V 40/10

(52) U.S. Cl. CPC G06V 20/54; G06T 7/246; G06T 11/26; G06V 10/25; G06V 10/764; G06V 40/10; G06T 2207/30196; G06T 2207/30232; G06T 2207/30236; G06T 2207/30242; G06V 2201/08

(57) ABSTRACT

A system, computing device and method for monitoring regions of interest by using sensors to detect objects that traverse the region, and counting the object by type.

### RELATED APPLICATION(S)

This application is a continuation of International Application No. PCT/US24/62361, filed Dec. 30, 2024, pursuant to 35 U.S.C. §§ 120 and 365(c); which claims the benefit of U.S. Provisional Application No. 63/615,560, filed Dec. 28, 2023, pursuant to 35 U.S.C. § 119(e); the aforementioned priority applications being hereby incorporated by reference in their entireties.

### TECHNICAL FIELD

Examples relate to a system, device and method for monitoring traffic and natural environment.

### BACKGROUND

Numerous types of devices and systems have been developed to monitor traffic and environments. Prior efforts in this field have encompassed a diverse range of technologies, each with inherent limitations. For example, cloud-based optical counting camera systems utilize high-resolution cameras to capture real-time traffic images. The data is processed using sophisticated computer vision algorithms in the cloud, allowing for accurate object counting and classification. However, these types of systems are dependent on continuous internet connectivity and raise concerns about privacy and data security, as identifiable images are transmitted and stored in the cloud. Moreover, these types of systems often consume more power than what can be made available through solar power. As a result, these types of systems tend to be tethered to a grid power supply.

Passive infrared (PIR) sensors are typically used for motion detection, by detecting changes in infrared radiation. While effective in detecting presence, PIR sensors lack the capability to distinguish between different types of objects, such as people, bicycles, or cars, limiting their application in detailed traffic analysis.

Inductive loop systems involve laying wire loops beneath the road surface to detect vehicles via changes in magnetic fields. While reliable for detecting metallic vehicles, they cannot detect non-metallic objects and provide no information about object classification or traffic flow characteristics.

There also exists specialized cameras equipped with radar or LIDAR technology. These types of cameras are deployed for measuring the speed of moving vehicles. Although they provide accurate speed data, they do not offer insights into traffic density, object classification, or environmental conditions.

Radar systems use radar technology to detect and measure the speed of moving objects. While effective for speed detection, radar systems generally do not provide detailed classification of objects or environmental data.

Other conventional systems use acoustic sensors to detect and analyze sound patterns. Acoustic sensors can infer traffic density and flow but cannot classify types of traffic participants or provide environmental data.

LIDAR technology is also employed in some advanced traffic monitoring systems to create detailed three-dimensional images of traffic scenes. While effective for mapping and object detection, LIDAR systems are typically complex, expensive, and do not inherently include environmental sensing capabilities.

Thermal imaging cameras detect heat signatures and can be used for traffic monitoring in low-light conditions. However, like PIR sensors, they struggle with object classification and do not provide environmental data.

Each of these technologies has contributed to the evolution of traffic and environmental monitoring systems but also presents specific limitations in terms of data privacy, object classification, accuracy, cost, and the ability to integrate environmental sensing.

### BRIEF DESCRIPTION OF THE DRAWINGS

FIG. 1 illustrates an example sensing system in accordance with one or more embodiments.

FIG. 2 illustrates an example method for monitoring regions of interest, in accordance with one or more embodiments. FIG. 2 illustrates an

FIG. 3 illustrates an example computing device for implementing a sensing system, in accordance with one or more embodiments.

FIG. 4 illustrates another example computing device 400 for implementing a sensing system.

FIG. 5A through FIG. 5D illustrate representation 500 of a region of interest, as described by various examples.

FIG. 6 illustrates an example method for setting up a sensing system, according to one or more embodiments.

FIG. 7A illustrates another example of a representation, for monitoring foot pathways, according to one or more embodiments.

FIG. 7B illustrates another dashboard interface, displaying a count by object for a particular region, according to one or more embodiments.

FIG. 7C illustrates another dashboard interface where objects are counted by direction of travel, according to one or more embodiments.

FIG. 7D illustrates a heat map interface for visually representing results of a monitored region, according to one or more embodiments.

FIG. 7E illustrates a ghosting visualization of tracks, or paths of travel, of detected objects, according to one or more embodiments.

### DETAILED DESCRIPTION

Examples provide for a system, computing device and method for monitoring regions of interest by using sensors to detecting objects that traverse the region, and counting the object by type. Additional information about objects that traverse regions of interest can also be determined and visualized.

Embodiments as described provide several significant advancements over prior art in the field of traffic and environmental monitoring systems. Its novel design and functionalities address the limitations of existing technologies, providing enhanced capabilities and benefits, all while maintaining a strong focus on privacy preservation.

Among other advantages, embodiments as described enable accurate identification and tracking of a wide range of objects, such as pedestrians, bicycles, vehicles, dogs, and sub-types of objects (e.g., adults versus children, motorcycles, scooters, flatbed trucks, etc.). This is achieved through advanced machine learning algorithms and computer vision techniques, allowing for more detailed and accurate traffic analysis. Compared to prior art like PIR-based sensors and inductive loops that have limitations in object classification, this system provides a richer data set, enabling more informed urban planning and traffic management decisions, without compromising individual privacy. By comparison, conventional approaches such as commonly used inductive loops or PIR lack the ability to differentiate between object types.

Additionally, embodiments as described enable functionality that extends beyond counting of objects. Embodiments enable determination of direction and speed of objects as they move across a region of interest. This capability surpasses many existing technologies, like basic inductive loops, which are limited to detecting the presence of vehicles without providing directional or speed information. It achieves this sophistication while ensuring that individual privacy is not infringed.

The integration of these advanced features into a single, cohesive system not only enhances the efficiency and effectiveness of traffic and environmental monitoring but also demonstrates a commitment to innovation in addressing contemporary urban and environmental challenges. Importantly, it does so while prioritizing privacy, setting a new standard in the field and offering a versatile, scalable, and user-friendly solution that is well-suited to the evolving needs of modern societies.

One or more examples described herein provide that methods, techniques, and actions performed by a computing device are performed programmatically, or as a computer-implemented method. Programmatically, as used, means through the use of code or computer-executable instructions. These instructions can be stored in one or more memory resources of the computing device. A programmatically performed step may or may not be automatic.

Additionally, one or more examples described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs, or machines.

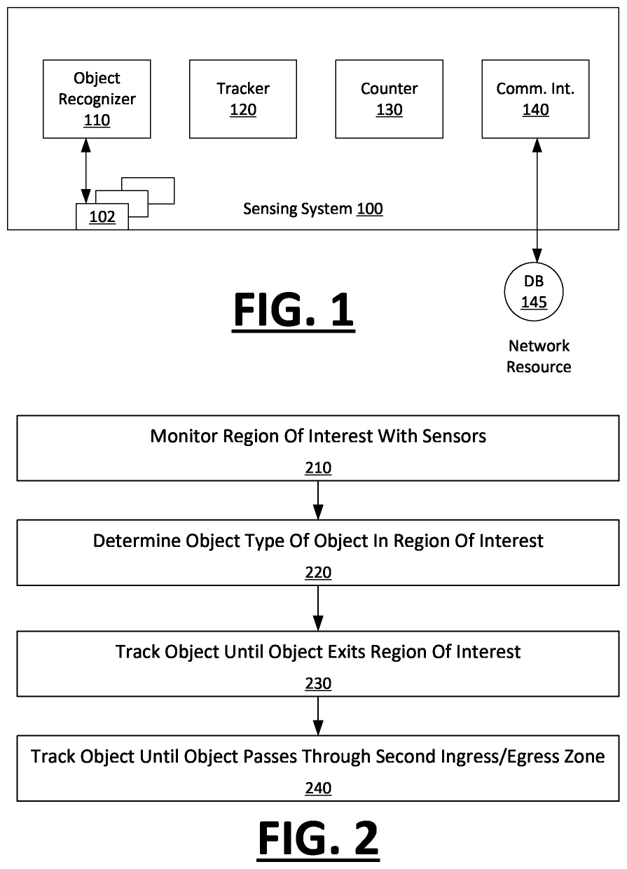

FIG. 1 illustrates an example sensing system in accordance with one or more embodiments. A sensing system 100 can be implemented as an integrated device that shares power and communication resources. In variations, the sensing system 100 is implemented as a combination of devices that communicate with one another. For example, the sensing system 100 can include a set of sensors (e.g., cameras) that are distributed about a region of interest to communicate with a controller that implements functionality as described.

In examples, the sensing system 100 operates to detect and count a number of objects that pass through a region of interest, where the region of interest is predefined within a field of view of the sensing system 100. In at least some examples, the sensing system 100 performs operations of detecting and counting objects, and reporting results that include a count of the number of objects detected, to an external site or device, without communicating or storing image data that is identifiable of the detected object. This allows the sensing system 100 to operate in public settings in a manner that maintains privacy of persons who pass in view of the systems sensors.

The sensing system 100 is configured to perform processes represented by object recognizer 110, tracker 120, counter 130 and communication interface 140. The object recognizer 110 receives raw sensor data from one or more sensors 102 that are connected to or integrated with the sensing system 100. The sensors 102 can include a camera to capture raw image data (e.g., video frames) which is then streamed to the object recognizer 110.

The object recognizer 110 processes image data of the camera(s) 102 to detect and recognizes each moving object by type. In implementation, object recognizer 110 can receive a series of frames from the camera 102. The object recognizer 110 performs image analysis on each frame. For each frame, examples provide that each pixel in the camera is mapped to an artificial neuron in software which is then coupled to several layers of neurons. Each of these layers is designed to recognize patterns and map those patterns to object classes (such as person, bicycle, car, etc.).

In examples, the object recognizer 110 can associate each detected object with a object type. For example, the object recognizer 110 can label each object in a scene captured by the sensors 102. In performing image detection and classification, the object recognizer 110 utilizes computer vision processes, including deep learning techniques, such as a neural network (e.g., a convoluted neural network (CNN)).

In examples, the sensing system 100 can be preloaded with one or more pre-trained, machine-learned image recognition or classification models, trained specifically for object types of interest. The training of the models can incorporate a diverse data set, which can include images of objects of interest from different environments (e.g., urban settings, trails) and conditions (e.g., varying light, presence of shadows). Synthetic training sets can also be deployed. The resulting models can be trained to have robustness to varying size, shadow, lighting conditions and other situational context. An iterative process of testing, evaluating, and refining these models is employed to continuously enhance and improve the models.

The object recognizer 110 utilizes one or more such pre-trained models to analyze individual frames of images, to detect objects of particular types. Further, the object recognizer 110 can recognize objects such that the objects can be recognized and tracked from frame to frame. In examples, the object recognizer 110 uses a You Only Look Once (YOLO) algorithm and/or Deep SORT, to develop the image analysis models and analyze the images using the models. The object recognizer 110 can also implement models to detect and ignore static objects, such as parked vehicles.

The tracker 120 includes processes that utilize a tracking algorithm to track an object from detection in an initial frame, to subsequent frames. Upon detection, the tracker 120 assigns a unique identifier to each detected object. The tracker 120 recognizes that an object detected in a video frame is likely to be present in the next video frame, until the object exits the view of the camera. When multiple objects are concurrently captured by a series of video frames (e.g., 10-60 fps), the tracker 120 ensures that each object assigned to an identifier is not counted twice over the series of video frames. Further, to ensure precise counting and avoid duplicating counts for the same object, the system applies deep learning techniques in its computer vision processes. This can include mapping each pixel to an artificial neuron, with multiple neural network layers recognizing patterns and classifying them into object categories. The tracker 120 can also identify obfuscations as they occur, such as when one pedestrian walks behind another in a given frame.

The counter 130 counts each type of object that appears in the field of view of the sensors 102. In at least some examples, the counter identifies for each detected object, the track (or path of travel) of the object while it is in a region of interest, within the field of view of the sensors 102. When a tracked object is determined to exit the region of interest, the counter 130 updates account for the type of object that was detected.

In some examples, additional metrics and information associated with a tracked object can also be recorded. Such metrics can include i) a speed of an object, ii) a dwell time of an object in a region of interest, and/or iii) a direction of movement of the object. In additional variations, a track of the object through the region of interest can be recorded. Various types of additional information can also be recorded, such as the object type and other metadata, audio clip of the noise made by the object passing through the region of interest, and/or contextual information determined by the sensors at the time of the object detection (e.g., time of day, lighting condition, temperature, humidity, etc.).

As described with examples, the sensing system 100 can track object within a defined region of interest, and within the camera's field of view. The sensing system 100 records each object's entry and exit from the region of interest, capturing data on the time spent within this region and the entry and exit points, thereby enabling speed and direction estimates.

The communication interface 140 transmits information (“event data 142”) determined by the sensing system 100 to an external device or network site (represented by dashboard 145). The event data 142 can include, for example, (i) a count of, or increment thereof, of an object type that appears in the region of interest over a given time interval, and/or (ii) metrics and other information recorded with each detected object, such as object velocity and path of travel (or track) through the region of interest. In at least some examples, image data (e.g., video) of the detected objects is not transmitted from the sensing system 100, at least not in sufficient form to enable identification of persons or objects beyond their respective classification. For example, as described in some examples, image data in the form of an outline of the detected object may be recorded, without any details of the object within the outline being recorded or transmitted.

The communication interface 140 can transmit event data 142 on a periodic or event-driven basis. The communication interface 140 can be programmed or otherwise configured to transmit event data 142 in accordance with a selected configuration, configurable by an operator of the sensing system 100, such as in accordance with a predetermined schedule and/or in response to predefined events. For example, the communication interface 140 can transmit event data 142 every hour of the day. Alternatively, the communication interface 140 can be configured to transmit event data 142 periodically during a time interval when a relatively high level of traffic is present in the region of interest (e.g., during sunlight hours). When traffic is expected to be minimal, the communication interface 140 can transmit event data 142 in response to detecting an event, such as an object passing through the region of interest.

In examples, the sensing system 100 does not transmit images off-device. Rather, in examples, the sensing system 100 records and transmits data indicating an occurrence of an object in a region of interest, count(s) of object by type in the region of interest, metrics associated with detected objects (e.g., velocity and direction of object), the object's track, contextual information (e.g., temperature, ambient light, etc.) and metadata. If any image data is recorded or transmitted, it obscures, obfuscates or replaces pixels of persons and/or identifiable features of objects (e.g., license plates)

Further, examples provide for the sensing system 100 to be configured to operate efficiently on low power sources, such as solar or battery power, enabling the sensing system to be operated in remote areas or locations with limited power infrastructure.

In additional examples, the sensing system 100 is equipped to operate effectively at night. This low power, all-conditions operability extends the utility of the system beyond conventional monitoring devices, particularly in context of less accessible or non-urban areas.

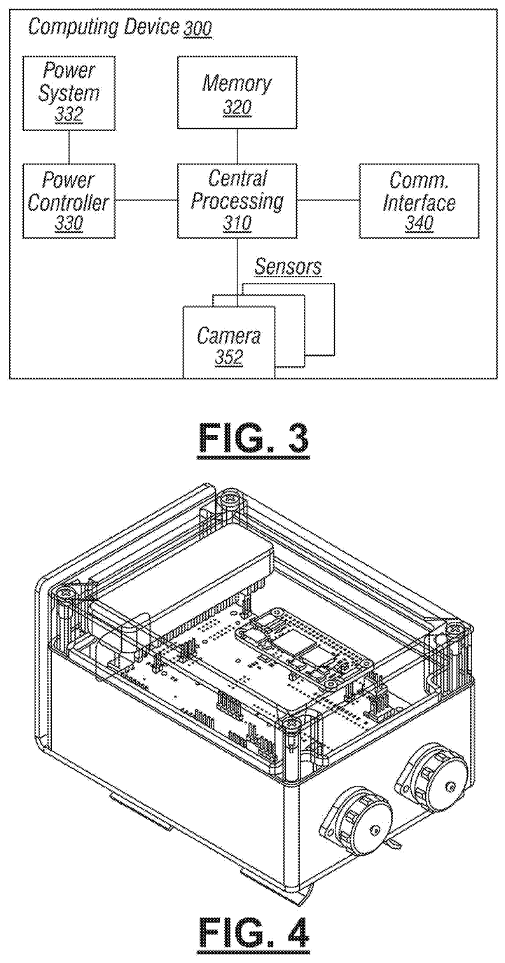

FIG. 2 illustrates an example method for monitoring regions of interest, in accordance with one or more embodiments. An example method of FIG. 2 can be implemented using, for example, functionality described with a sensing system such as described with an example of FIG. 1. Accordingly, reference may be made to elements of FIG. 1 for purpose of illustrating suitable components or functionality for implementing an example of FIG. 2.

With reference to FIG. 2, a region of interest is monitored by sensors to detect one or more types of objects (210). The region of interest can be defined as a region within a field of view of the sensors. In additional examples, the region of interest can be defined by multiple ingress and/or egress zones (also referred to as trigger zones). In such examples, an object can be detected when it passes through a trigger zone.

After an object enters the region of interest, an object type is determined for the detected object (220). The object type can be determined from sensor data provided by the sensors. The sensors can include cameras, and the sensor data can include video frames of the object. The detection of the object type can then be based on image processing, using for example, a classified that is trained for particular types of objects. In variations, additional types of sensor data can be used to track objects, such as microphones, infrared cameras (or heat sensors), sonar and the like.

The object is tracked until the object exits the region of interest (230). This can correspond to the object passing through an egress zone after it has passed through an ingress zone. By way of illustration, a given region of interest can include predefined regions that are each designated as being both ingress and egress zones. In such case, a tracked object is deemed to pass through the region of interest when it passes through a first one of the predefined zones, then through a second one of the predefined zones. The tracked object can also be deemed to have passed through the region of interest when it passes through the first predefined zone and turns around and exits the scene through the same predefined zone.

The occurrence of the object being detected in the region of interest is then recorded (240). In examples, a record of the object type being detected in the region of interest is made. As an addition or variation, the occurrence of the object type in the region of interest increments a counter (242). In other variations, the occurrence of the instance is transmitted to another device or resource, where a count of objects by type being detected in the region of interest is made. In context of counting, an object can be identified by one or more types, and the counter can be incremented for the object by type. Additionally, determination can be made as to whether a detected object is to be counted, based on predefined conditions, such as a track of the detected object. For example, the sensing system 100 can implement rules and other logic to determine when and if an object is to be counted. By way of illustration, the sensing system 100 can be configured by one or more rules to count objects of particular type when the objects are detected to enter and exit the region of interest through different ingress and egress zones. Alternatively, the sensing system 100 can be configured to count every object that enters the region of interest, through any entry point.

As an addition or variation, one or more metrics associated with the detected object can be record. The metrics can include speed, direction of travel, and/or dwell time of the object within the intersection. Additional information can also be recorded with the detected object, such as the track of the object through the region, as well as other information (e.g., contextual information).

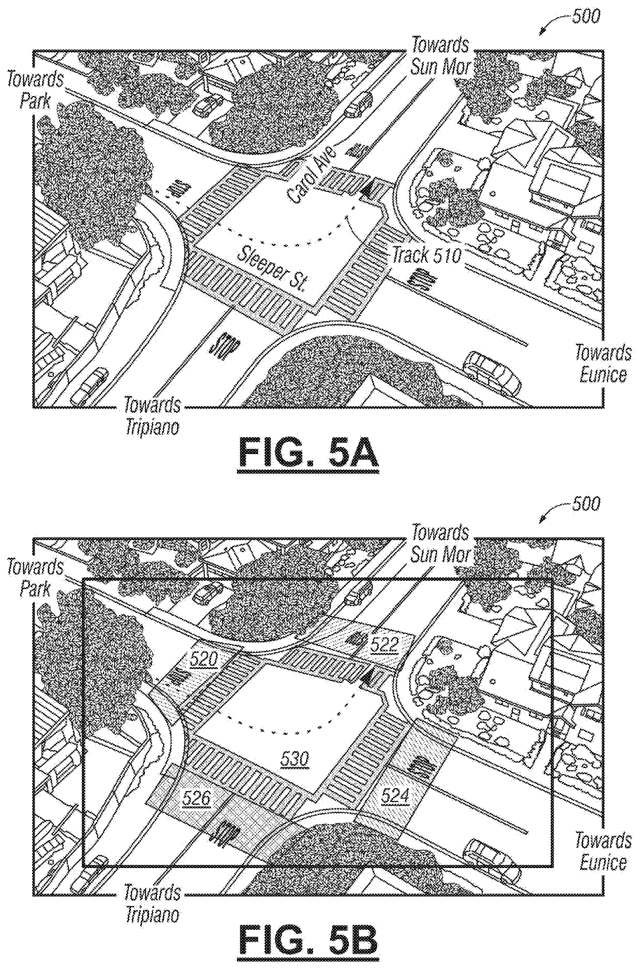

FIG. 3 illustrates an example computing device for implementing a sensing system, in accordance with one or more embodiments. An example sensing device 300 can include a central processing unit 310, memory resources 320, a power controller 330, a power system 332, one or more communication interfaces 340 and a set of sensors, where the set of sensors can one or more cameras 352. The camera can be a monocular camera. In variations, the set of sensors can also include one or more microphones, infrared sensors, sonar, ambient light sensor, barometer, thermometer, and the like.

In operation, the central processing unit 310 receives image data from the 352. The central processing unit 310 executes instructions for implementing functionality described with the object recognizer 110, tracker 120, and counter 130, such as described with an example of FIG. 1. The memory resources 320 can store results of the operations, including a count of object types detected in a region of interest. The memory resources 320 can also store instructions for implementing functionality as described with, for example, sensing system 100. As an addition or variation, the memory resources can store instructions for performing a method such as described with an example of FIG. 2, or with other examples.

The power system 332 includes a battery unit, a power bus to distribute power, and a power inlet. In some examples, the power system 332 includes a DC interface to receive power from a solar cell (or combination of solar cells).

The power controller 330 controls the operational level of the computing device 300. In examples, the power controller 330 implements routines to optimize the power usage of the device 300, to extend the battery charge. For example, the power controller 330 can maintain a schedule, or list of conditions, under which the power level of the computing device 300 is to be switched into a sleep mode, or deep sleep mode. The schedule can identify, for example, evenings and early mornings as being quiet periods to switch to deep sleep. In the case where the computing device 300 is deployed in a remote location (e.g., public park), the sensors can detect, for example, weather conditions, such as rain or cold temperatures, to switch to deep sleep, under expectation that few persons would be in the park. As an addition or variation, the power controller 330 can manage which devices are operative, given a particular state or context. Further, when the sensing system 100 or computing device 300, 400 runs at night, the system can choose to sleep or run and has hardware support to turn on supplemental illumination if not enough light is present. This is through any of: 5pin bus connection on bottom (currently the temp/humidity sense also uses this) or via BLE/LoRa/Wi-Fi or cell network. The determinations can be based on the power controller, implementing an optimization profile for use of power in the particular device or system.

The communication interfaces 340 can enable the device 300 to communicate using, for example, communication protocols such as defined under any of the 802.11 standards (“WiFi”), such as 802.11(a), (b), (g), (n), (ac), (ax), (ad) and (ah). As an addition or variation, the communication interface 340 can communicate using LoRa, Zigbee, Bluetooth, Bluetooth LE or other wireless communication protocol.

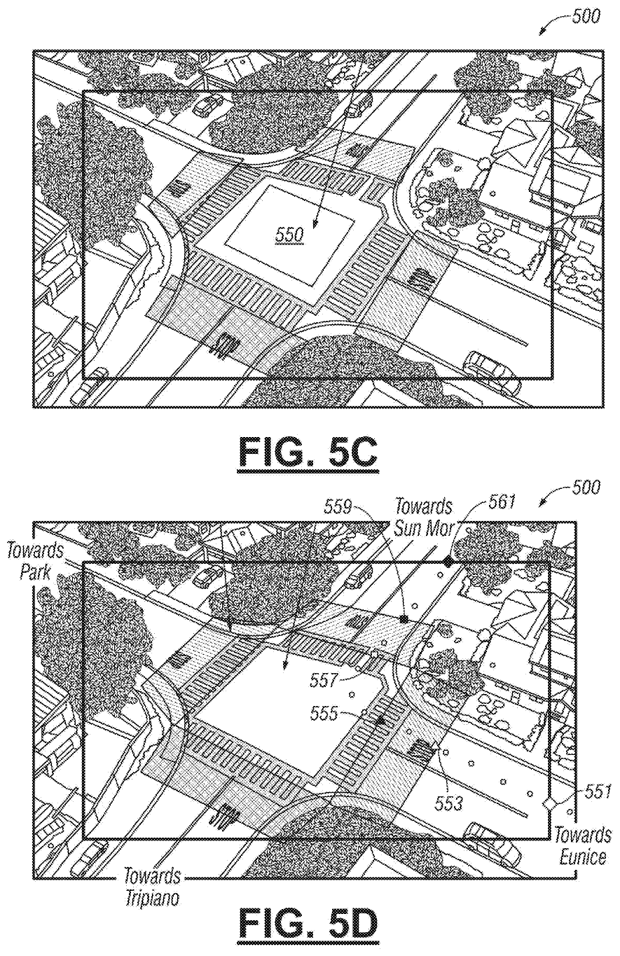

FIG. 4 illustrates another example computing device 400 for implementing a sensing system. The computing device 400 provides an example of a computing device 300 such as shown in an example of FIG. 3. The computing device 400 can include a housing 410, with components such as described with FIG. 3 or with other examples. The housing 410 can include features for enabling the computing device 400 to be mounted to a structure, tree or other feature that is adjacent to a region of interest. The housing 410 can provide for one or multiple camera lenses, as well as apertures or surfaces on which different types of sensors can be mounted. Still further, solar cell(s) (not shown) can be mounted on top or near the housing 410 to charge a battery contained within the housing. The housing can be tilted or oriented before being mounted, and then locked into position after being mounted. The locking can prevent the camera from losing its position, and prevents the device from losing its calibration as a result of movement.

In examples, the computing device 300, 400, or alternatively, its camera sensors (if detachable), can be mounted at a height of 12-15 feet above ground level to optimize the field of view for traffic observation and to minimize occlusions. This strategic positioning enhances the computing device's ability to capture a clear, unobstructed view of the traffic area of interest.

In examples, the computing device 300, 400 is a mobile-mounted sensor, equipped with a camera positioned to monitor traffic flow. The sensor can be powered through various means: solar power, line power, or battery power, with the latter capable of sustaining the device for over a week or longer. In examples, the operation of the computing device 300, 400 can deploy continuous running machine learning models, which are adept at recognizing and tracking persons, bicycles, and vehicles. Each identified object within the camera's field of view is tracked throughout its presence and assigned a unique identifier. Upon exiting the camera's tracking area, the object is recorded along with a time stamp. The frequency of data upload to a network site or web dashboard is configurable, with intervals ranging from every minute to daily updates. The computing device 300, 400 has the capacity to store several months' worth of data, facilitating its use in remote locations with 4G connectivity for data transmission.

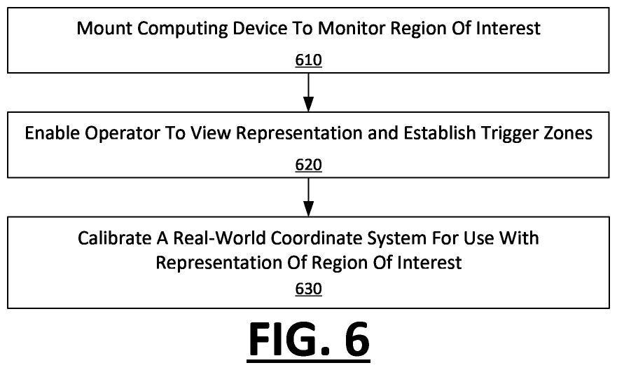

FIG. 5A illustrates an example representation 500 of a region of interest, as described by various examples. The representation 500 can be rendered or otherwise displayed to a remote user via a network connection (e.g., as part of the dashboard). The representation 500 can be provided for a variety of purposes, including (i) setting up a computing device 300, 400 on which the sensing system 100 is implemented; (ii) checking or reconfiguring (e.g., recalibrating) the computing device 300, 400; and/or (iii) viewing tracks of specific objects that have been detected as passing through the region of interest.

In an example of FIG. 5A, the region of interest corresponds to an intersection. As shown in the example, the sensing system 100 or computing device 300, 400 detects an object of type vehicle enter an intersection (e.g., from Sleeper Street, turns left, and exits the region of interest via Carol street. The sensing system 100 or computing device 300, 400 records the instance of the vehicle entering the intersection, update the count for objects passing through the intersection (by type and/or for all objects), and records directional information about the object (e.g., vehicle entered intersection on Sleeper Street, exited on Carol Ave.). Further, in an example shown, the representation 500 can be modified by a track 510. The track 510 is an example of an output that can be generated by the sensing system 100 or computing device 300, 400. For example, the tracker 120 can generate track data that can be rendered to visualize the track 510 the object takes in passing through the region of interest. The visualized track 510 can be rendered as, for example, a layer over a depiction of the region of interest.

Additional metrics can also be recorded regarding the vehicle, such as the speed of the vehicle. The speed can include identification of the vehicle's average speed while it was in the region of interest. As an addition or variation, the maximum and minimum speed of the vehicle can also be determined and recorded.

The following illustrates a process for determining an average speed of an object traversing a region of interest. In such case, the speed of the object will be based on the distance between first entry into the initial trigger zone and the last entry from the last trigger zone. Given that each of the points can be represented by (x,y,t), the speed of the object can be expressed as:

Speed=Distance (Wexit_(x,y), Wentry_(x,y))/Time (Wtime_exit−Wtime_entry)

Another metric that can be recorded with the vehicle is the dwell time, referring to the amount of time that the vehicle was in the region of interest. This can be determined by calculating the difference in time between when the object was first detected and just before it was determined to have exited the region of interest.

Another type of information that can be recorded can include (i) whether the vehicle had a near miss with another object in the intersection, and/or (ii) whether a collision occurred in the intersection. Still further, another type of determination that can be made is whether another object, or object of a particular type, entered the region of interest while the vehicle was present. These types of determinations, when recorded, can facilitate safety planning for a monitored region.

With further reference to FIG. 5A, the track 510 can be made available from the object recognizer 110 and the tracker 120. The track 510 can be determined from a list of points, where each point represents an (X, Y) screen coordinate and a corresponding time stamp (t). For example, the track 510 can be determined from the following coordinates, as determined from the object recognizer 110 and the tracker 120:

Track=[[x0, y0, t0], [x1, y1, t1], . . . [xn, yn, tn], . . . , [xlast, ylast, tlast]]

To generate a track, the assumption is made that the camera is mounted and calibrated, and the camera is no subsequently moved.

FIG. 5B illustrates another example representation 500 of a region of interest, as described by various examples. In an example shown, the representation 500 includes trigger zones 520, 522, 524, 526. The trigger zones 520, 522, 524, 526 can be rendered as overlays of the representation 500. Each trigger zone 520, 522, 524, 526 can be predefined, as a configuration for the sensing system or device. In an example shown, each trigger zone 520, 522, 524, 526 corresponds to an ingress or egress for the region of interest.

In an example shown by FIG. 5B, to get directional mapping, the sensing system 100 or computing device 300, 400 determines when (e.g., based on timestamps) the object enters the trigger zone 520, and when the object leaves the trigger zone 522. More generally, the direction of travel of an object can be determined by (i) identifying an object when it first enters the region of interest at one of the trigger zones 520, 522, 524, 526, (ii) tracking the object until it exits the scene from one of the 520, 522, 524, 526, and (iii) determining the direction of movement as being from the trigger zone of ingress to the trigger zone of egress.

Dwell Time: With reference to an example of FIG. 5B, dwell time can be calculated based on (i) the initial time stamp of when the object enters either the region of interest or the ingress trigger zones 520, 522, 524, 526, and (ii) the last time stamp of the object being in the region of interest or in the egress trigger zone 520, 522, 524, 526. In examples, the dwell time can be calculated as the difference between the initial timestamp and the last timestamp.

With further reference to FIG. 5B, an operator of the sensing system 100 or computing device 300, 400 can interact with the representation 500 or an associated user-interface in order to specify dimension and shape for each trigger zone 520, 522, 524, 526 of a region of interest 530. For example, the operator can draw an overlay on the representation to indicate each trigger zone 520, 522, 524, 526. Through the interaction with the representation 500, each trigger zone 520, 522, 524, 526 can be custom sized and shaped to match the requirements of the environment. For example, if the sensing system 100 or computing device 300, 400 is to detect and count pedestrians and vehicles, then the operator can configure each 520, 522, 524, 526 to encompass the intersection roadway and sidewalk. In the case where animals such as dogs are to be detected, the 520, 522, 524, 526 can be shaped (e.g., trapezoidal) to capture animals which may avoid the sidewalk. Further, in edge cases, it is possible for a track of an object to squeeze between defined trigger zones 520, 522, 524, 526. To avoid such edge cases, the trigger zones 520, 522, 524, 526 can be defined to touch one another.

Speed Determination: To obtain a metric of speed for an object, during a set up phase, each point of the representation 500 is mapped to a point in the real-world (e.g., the ground). This can be accomplished by calibrating one or more features of the real-world to corresponding screen coordinates. Once a real-world mapping is established between points on the screen and points in the real-word, points on a track can be mapped to coordinates in the real-world. Each track point (on screen) can be mapped to a real-word coordinate, and each track point can also be associated with a timestamp. The speed of an object between two points of the track can be determined, by using the real-world mapping to determine real-world coordinates for the track points, and from the real-world coordinates, determining a distance of travel for the portion of the track that is identified by the selected track points. The difference between the timestamps for the two track points can be used to determine the time of travel. Then the speed of the object between the two selected track points can be determined and displayed. For example, the speed can be displayed as part of the representation 500, or separately as part of one of the metrics generated by the computing device 300, 400.

The speed metric can be determined in a variety of ways, such as average speed, maximum speed, minimum speed, etc. The determination can be made for a portion of a track in the region of interest, or for the interval during which the object traverses the region of interest.

In examples, to improve accuracy when measuring distance of travel, the object recognizer 110 and tracker 120 determine track points where the object is in contact with the ground, rather than, for example, the centroid of the object. Thus, for example, for a person, the object recognizer 110 and tracker 120 can focus on shoes or feet of a person to determine the track. For vehicles, the object recognizer 110 and tracker 120 can focus on wheels to determine the points of the track.

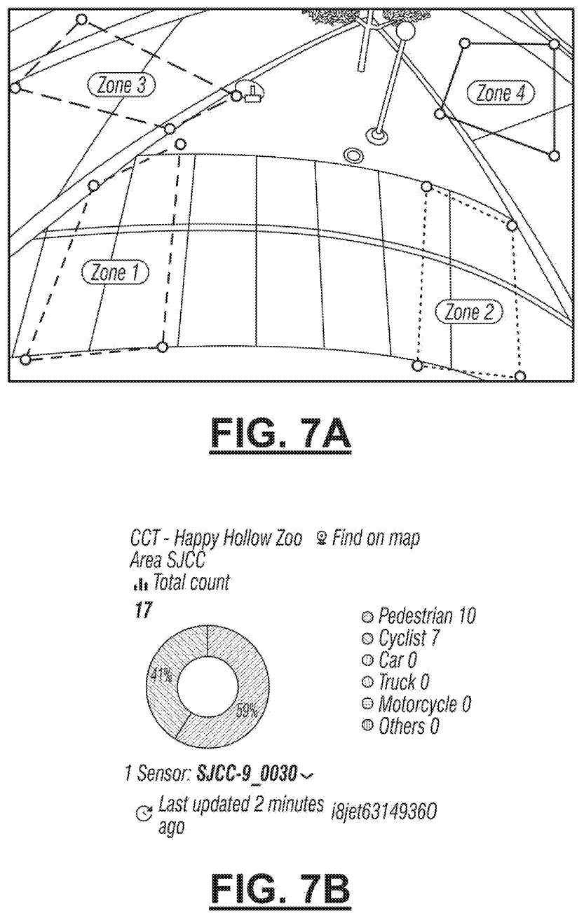

FIG. 6 illustrates an example method for setting up a sensing system, according to one or more embodiments. A method such as described with FIG. 6 can be implemented using a sensing system or computing device as described with any of the examples described herein. Accordingly, reference is made to elements of other examples for purpose of illustration.

With reference to an example of FIG. 6, the sensing system 100, or computing device 300, 400 that integrates the sensing system 100, is mounted to monitor a region of interest (610). The sensing system 100 or computing device 300, 400 can be mounted to provide the cameras and sensors with a target elevation and orientation.

During the setup phase, an operator can view the representation of the region of interest to specify trigger zones, representing areas of ingress or egress with respect to the region of interest (620). In examples, the orientation of the cameras for the sensing system 100 or computing device 300, 400 is typically askew (e.g., see FIG. 5B). Accordingly, the trigger zones can be drawn or otherwise configured geometrically by an operator to capture, on screen, the desired area of ingress or egress.

Further, during the setup phase, an operator can calibrate a real-world coordinate system for use with, for example, an image or representation of the region of interest (630). In examples, to calibrate the ground world coordinate system, a known feature is placed in the field of view of the camera. The requirements for the feature is that it is shaped to have at least three non co-linear points or sides, such as can be provided by a triangle-or square-shaped object. The larger the feature, the more accurate the calibration will be. For example, as shown by an example of FIG. 5C, an installer can place or form a rectangular feature 550 in a center area of the region of interest, and the rectangular feature 550 can then be included in the representation 500. The dimension of each side (non-colinear) of the rectangular feature 550 may be known, or determined at time of setup. Further, once the feature is placed, it can be fixed—meaning angles between the sides does not change. As the camera has both elevation and yaw angle relative to the ground, the result is that the rectangle takes a trapezoidal appearance.

In examples, the calibration step can include creating a transform matrix (M), which takes a real-world coordinate and returns a screen coordinate. Once the transform matrix M is determined, an inverse of the matrix can be used to map screen coordinates back to real-world coordinates.

For real-world points (W_1, W_2, W_3, W_4), there exists for four camera screen points (C_1, C_2, C_3, C_4)

For the relative-world points this can:
W_1: (0,0)
W_2: (0,x)
W_2: (0,y)
W_3: (x,y)

Where x,y represent distance in meters or feet. In variations, other types of coordinates can be used, such as longitude or latitude. Likewise, alternatively, the camera screen points can be angular coordinates, with the assumption that the field of view of the camera is fixed horizontally and vertically, such as for example:
Normal Oak: 81° (x)/69° (y)
Wide Oak: 120° (x)/95° (y)

The aforementioned coordinates can be used to calculate the distance from the camera to any point on the ground in the field of view.

Given a point in the world W we can map to a point in the camera coordinates as follows:

M*Wₙ=Cₙ

Where this is equivalent to=

|a b c|*|Wₓ|=|Cₓ|

|d e f| |W_{y}| |C_{y}|

|0 0 1| |0| |0|

What results at this step is 4 points (which is 8 measurements) and 6 unknowns as follows:

W1*M=C1

W2*M=C2

W3*M=C3

W4*M=C4

A process such as Least Squares can be used to solve for M, since each point W and C is known.
function solveLeastSquares(M, b):
//Compute the transpose of M
M_transpose=transpose(M)
//Compute (M\hat{ }T*M)
MTM=M_transpose*M
//Compute (M\hat{ }T*b)
MTb=M_transpose*b
//Solve for x using the equation: x=(M\hat{ }T M)\hat{ }−1 M\hat{ }T b
//Here, we assume a function “inverse” which computes the inverse of a matrix
x=inverse(MTM)*MTb
return x

The central processing unit 310 can, for example, execute a matrix solver to make the determinations noted above.

Once the matrix M solved, it allows both forward and inverse transformations (world to camera and camera to world).

When a track at camera coords C(x,y) is determined, the inverse of the Matrix M can be used to compute the world coordinates W(x,y):

C*M−1=W

Once calibration has been performed, various metrics can be obtained in connection with an object traversing the region of interest:
Dwell time in the ROI
Entry and Exit regions (to get direction)
Average Speed in the ROI, (also peak speed)
Average Speed between the first and last trigger area entrees, (also peak speed)
Distance traveled in world coordinates
Distance traveled in screen coordinates

Assuming that the object classification is handled by the object recognizer 110 and tracker 120, the calibration enables each track to be represented as a series of real world coordinates (with timestamps):
Track—a list of points in screen coordinates [[x0, y0, t0], [x1, y1, t1], . . . [xn, yn, tn], . . . , [xlast, ylast, tlast]]

Further, a world-to-camera matrix (M) can be determined for mapping coordinates:
World-to-Camera Matrix—M

The region of interest and its defined trigger zones can also be represented by real-world coordinates:
ROI polygon—list of points in screen coordinates [[[x0, y0], [x1, y1], . . . [xn, yn,], . . . , [xlast, ylast]]

Note that in the illustrations the RIO is treated as a rectangle, but for our discussion here this is not necessary. Having a true polygon also allows more complex regions to be mapped, but at the expense of user interface complexity

Trigger Polygons—a list of polygons of this form:
{“label”: <string>, vertices: [list of screen coordinates]}

The track vector can be walked through to determine various types of metrics. However, the track vector is in screen coordinates, while the object is in real-world coordinates. Further, the track vector is sparse, as the object skipped around the viewable area so we need to estimate when the object first enters and exits the region of interest. One implementation provides for connecting the points between each entry on the track vector and move pixel by pixel on the connected line segments and test for intersection of regions of interest.

It should be appreciated that in other examples, other processes or algorithms can be used to calibrate the system and utilize information such as tracks.

FIG. 5D illustrates the representation 500, in context of a track vector. Each pixel on the track is marked with a circle. The diamond point 551 illustrates the point where the object first enters the region of interest. The triangle 553 represents the point where the object enters the first trigger zone. The dark triangle 555 represents the point there the object leaves the first trigger zone. The square 557 represents the point where the object enters the last trigger zone. The dark square 559 represents the point where the track leaves the last trigger zone. The larger dark diamond 561 represents the point where the object leaves the region of interest.

In a vector tracking process, a track vector is traversed, marking where the region of interest is reached. Linear interpolation can be used to determine between successive points in the track, so that an estimated entry and exit point for the region of interest, the first trigger zone, and the last trigger zone is determined. Once the points are determined, the track vector can be trimmed such that the track vector provides just the points that occur in the region of interest and also those points added by testing for the first and last trigger zones and/or entry/exit points (which can include interpolated points). The resulting track vector can be used to determine:
Dwell_time−time_last_point_in_ROI−time_first_entry_in_ROI

It is likely these points are interpolated

Track_distance_screen=the sum of intra-point distances between the first entry point in the ROI and the subsequent distance of each track line segment, until reaching the last entry in the ROI.

Track_distance_world=transform all the track points from first entry point to last exit point from screen to world coords. Then compute distance in the same manner as screen coords.

Track speed=Track_distance_world/Dwell_tim

First_trigger_area=point-in-polygon of first point in track in a trigger area

Last_trigger_area=point-in-polygon of exit point in track in a trigger area

Time_in_first_trigger_area=subtract times from last/exit points (interpolated) in first_trigger_area

Time_in_last_trigger_area=subtract times from last/exit points (interpolated) in last_trigger_area

Time_in_common_area=(assuming no looping around)=time_of_exit_from_first_trigger_area to time_first_point_in_last_trigger_area

Distance_in_common_area=transform all the track points from exit_point of first_trigger_area to first point in last_trigger_area from screen to world coords. Then calculate inter segment distances and sum up

Speed_in_common_area=Distance_in_common_area-Time_in_common_area

### Additional Examples and Usage Scenarios

Examples can monitor a region of interest that corresponds to an area trafficked by vehicles, to determine, for example, the incidents of near miss collisions and/or collisions. The determination process can include:

Determining tracks for two vehicles, and using interpolation to estimate track segment between points.

Determine if overlapping times exist with respect to the track.

If overlapping times exist, both tracks are trimmed as described with a track vector process provided above. The track of each object can be walked through as described above, and at each point, a difference is computed between time-aligned points of one track (Track A, for vehicle A) and the other track (Track B, for vehicle B). The result of the difference is vector distance. The vector difference can be analyzed to determine whether there was a near miss between the two vehicles. In determining whether there was a near miss, the differential velocity distance at each point on the difference vector can also be estimated based on the instantaneous speed for each track. The computing device 300, 400 can compute the angle of intersection between each track's velocity vector and the distance between tips of their respective instantaneous velocity vectors.

### Camera To Ground Distance

In examples, the computing device 300, 400 can detect a grounding point of an object, such as the shoes of a person, wheels of bicycle or tires of a vehicle. The distance to ground to that point can be determined, based on the angular resolution of the camera (the camera's x, y fan out in degrees instead of pixels, also known as the camera frustum). The distance from the camera to any point in the ground plane cane be determined using analytic geometry, by computing where the camera frustum hits the plane of the ground as determined by the matrix M. Note that the frustum is a skewed clipped trapezoidal pyramid in the general case of a camera viewing the ground plane at given declination and yaw angle.

### Object Size Estimation

Examples also enable the sensing system 100 or computing device 300, 400 to estimate the height and width of an object in real word dimensions. The relationship of the object to the ground may be known (e.g., person standing on the ground). Further, a pose of the object relative to the camera or world can be determined. While the object is plumb (normal with gravity), an assumption cannot be made that the ground plane is normal to gravity (it can be skewed relative to the gravity normal vector). However, this skew can be accounted for, to enable determination of the object size, using the world transformation matrix M.

### Additional and Alternative Examples of Representations

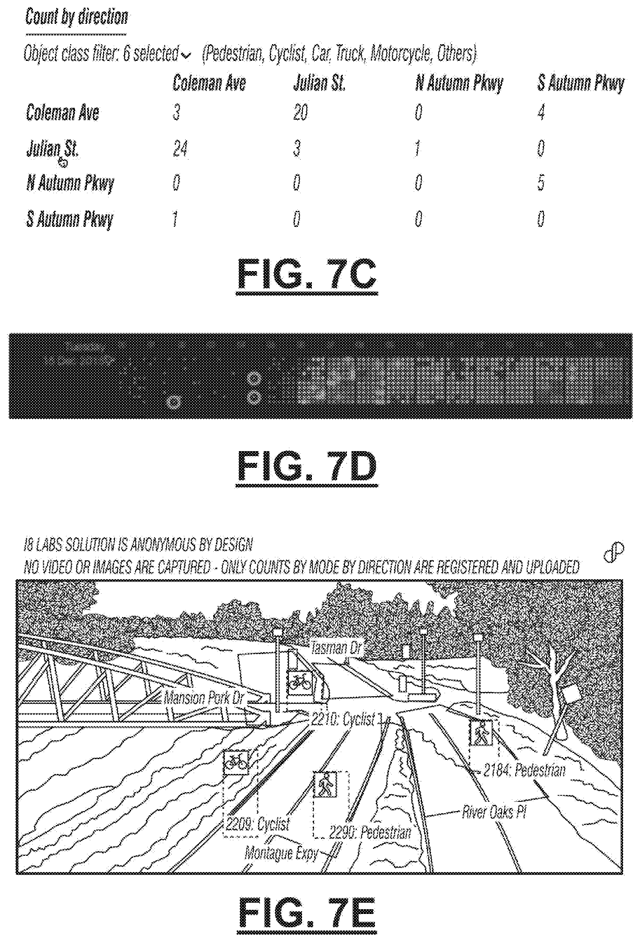

FIG. 7A illustrates another example of a representation 700, for monitoring foot pathways. In the example shown, three separate pedestrian paths are present. The sensing system 100 or computing device 300, 400 can be strategically positioned to monitor foot traffic and determine which pathway pedestrians use when traveling in a particular direction. An operator can set up and configure the trigger zones 712, 714, 716, 718 to cover all potential ingress and egress points to a region of interest (the interconnecting pathway). As described with other examples, the trigger zones 712, 714, 716, 718 can be configured through an operator interacting with the dashboard (e.g., while viewing a representation 700 of the region of interest). The trigger zones 712, 714, 716, 718 can be shaped to capture pathways users may take, including edge cases such as when a pedestrian cuts across a dirt section next to the path.

FIG. 7B illustrates another dashboard interface 720, displaying a count by object for a particular region. Each count can be generated from a time of reference, such as daily, monthly (e.g., first of each month), or from a set date. When a object of a particular type is counted by the sensing system 100 or computing device 300, 400, the count for that object type is incremented.

The sensing system 100 or computing device 300, 400 can be made scalable to monitor and count for different types of objects over time. For example, after made operational, the sensing system 100 or computing device 300, 400 can receive additional models and algorithmic processes for detecting and counting dogs, horses, etc.

FIG. 7C illustrates another dashboard interface 730 where objects are counted by direction of travel. As described, the direction of travel can be defined by the sequence of trigger zones the objects traverse when passing through the region of interest.

FIG. 7D illustrates a heat map interface 750 for visually representing results of a monitored region, according to one or more embodiments. In examples, the heat map interface 750 can be generated from the dashboard (via the communication interface with the sensing system 100 or computing device 300, 400). Various types of heat map paradigms can be implemented to indicate a count (or frequency of occurrence) of an object traversing the region of interest. In the example shown, the count for the objects is shown by dots, such that the greater the number of dots, the greater the count is. Additional metrics, such as velocity or dwelling time can be represented by color or other characteristics. Further, as shown, the heat map 750 can be segmented by time.

FIG. 7E illustrates a ghosting visualization 760 of tracks, or paths of travel, of detected objects. Each determined track can be visualized as a path and associated with an icon or other non-identifiable visual element that indicates the type of object that the track corresponds to. The ghost visualization 760 can be rendered as part of the dashboard for an operator. However, as the ghost visualization is anonymized (by showing icons and generic visuals for objects), in some examples, the ghost visualization can be made available to third-parties, including the public (e.g., via a website that interfaces with the sensing system 100 or computing device 300, 400).

### ADDITIONAL EXAMPLES

According to some examples, the sensing system 100 or computing device 300, 400 is a localized system that communicates output to a network resource, and receives models or algorithmic updates from the network resource. In additional examples, many of the tasks described with examples can be distributed between the local sensing system 100 or computing device 300, 400 and a network computing system. For example, a network resource (e.g., cloud computing resource) can continuously communicate with the sensing system 100 or computing device 300, 400 to determine speed, direction, time sequenced heat maps, etc., while the sensing system 100 or computing device 300, 400 performs tasks of object detection and tracking. The sensing system 100 or computing device 300, 400 can communicate anonymized data, such as tracks of objects with labels of the object data, rather than true image data of the scene. The network resource can calculate speed, direction, and generate heat maps based on the data communicated from the sensing system 100 or computing device 300, 400. In this way, more computationally intensive determinations can be made on the network/cloud computing source, however, the data used for performing such tasks is anonymized, such that privacy protection is maintained.

### CONCLUSION

It is contemplated for examples described herein to extend to individual elements and concepts described herein, independently of other concepts, ideas or system, as well as for examples to include combinations of elements recited anywhere in this application. Although examples are described in detail herein with reference to the accompanying drawings, it is to be understood that the concepts are not limited to those precise examples. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mentioned of the particular feature. Thus, the absence of describing combinations should not preclude having rights to such combinations.

What is claimed is:

1. A system for monitoring regions of interest, the system comprising:
one or more processors;
one or more cameras positioned to view a region of interest;
a memory to store instructions;
wherein the one or more processors execute the instructions to perform operations that include:
processing image data captured by the one or more cameras, including (i) detecting, from the image data, an object entering a region of interest, (ii) tracking, from the image data, the object traversing the region of interest, and (iii) detecting, from the image data, the object exiting the region of interest; and
in response to determining the object leaving the region of interest, updating a count of objects the type traversing the region.

2. The system of claim 1, wherein the operations further comprise determining, from the image data, a type of the object, and wherein updating the count of objects includes updating a count of objects of the type.

3. The system of claim 1, wherein the operations further comprise:
determining a dwelling time while the object is in the region of interest.

4. The system of claim 1, wherein the operations further comprise:
determining a speed of the object traversing the region of interest.

5. The system of claim 1, wherein the cameras are mounted to be elevated and askew of the region of interest, and wherein processing image data includes mapping the image data to a set of real-world coordinates.

6. The system of claim 5, wherein processing the image data includes determining a speed of an object traversing the region of interest, by mapping display coordinates reflecting the object's position as displayed to a corresponding set of real-world coordinates.

7. The system of claim 1, wherein the operations further comprise:
defining multiple trigger zones, each trigger zone being configured in shape and dimension specifically for the region of interest;
making a determination as to which of the multiple trigger zones the object traverses and in which sequence; and
based on the determination, determining a direction of travel for the object of interest.

8. The system of claim 7, wherein the operations further comprise:
transmitting information about the monitored region to an external computing resource;
based on the transmitted information, rendering a ghost visualization of the monitored region, the ghost visualization identifying objects by type, and each detected objects track when traversing the region of interest.

9. The system of claim 1, wherein the operations further comprise:
determining, based on the count, a heat map for the region of interest.

10. A method for monitoring regions of interest, the method being implemented by one or more processors and comprising:
processing image data captured by the one or more cameras directed towards the region of interest, wherein processing the image data includes (i) detecting, from the image data, an object entering a region of interest, (ii) tracking, from the image data, the object traversing the region of interest, and (iii) detecting, from the image data, the object exiting the region of interest; and
in response to determining the object leaving the region of interest, updating a count of objects the type traversing the region.

11. The method of claim 10, wherein further comprising:
determining, from the image data, a type of the object, and wherein updating the count of objects includes updating a count of objects of the type.
